(19) United States
(12) Patent Application Publication
(10) Pub. No.: US 2016/0196610 A1
(43) Pub. Date: Jul. 7, 2016

(54) GLOBAL FINANCIAL CRISIS PREDICTION AND GEOPOLITICAL RISK ANALYZER

(71) Applicant: GovBrain Inc., Washington, DC (US)

(72) Inventors: Brent M. Eastwood, Santa Fe, NM (US); Dustin Brand, Albuquerque, NM (US)

(21) Appl. No.: 14/990,637

(22) Filed: Jan. 7, 2016

Related U.S. Application Data
(60) Provisional application No. 62/100,818, filed on Jan. 7, 2015.

(51) Int. Cl. G06Q 40/06

(52) U.S. Cl. CPC G06Q 40/06

(57) ABSTRACT

A method (and non-transitory, computer readable medium comprising computer-readable code) for predicting a financial crisis event (and/or geopolitical risk), positive or negative, comprising receiving from a user a date range and a geographical scope of interest, aggregating prediction data from the date range and geographical scope from one or more of the asset classes currency, bond, commodity, and stock, automatically determining changes over time within the date range of one or more statistical analysis values of the aggregated prediction data selected from mean, median, mode, difference of means, standard deviation, variance, tolerance levels, skewness, kurtosis, inflection points and Bayesian analysis, and automatically reporting to the user a change outside of predetermined expected parameters.

### CROSS-REFERENCE TO RELATED APPLICATIONS

This application claims priority to and the benefit of the filing of U.S. Provisional Patent Application Ser. No. 62/100,818, filed on Jan. 7, 2015, and the specification and claims thereof are incorporated herein by reference.

This application is related to U.S. patent application Ser. No. 14/323,622, entitled “GovBrain® Method, Apparatus, and Computer Software,” filed on Jul. 3, 2014, and the specification thereof is incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

### Field of the Invention

1. Technical Field

The present invention relates to methods, apparatuses, and computer software for predicting various economic conditions or identifying specific systemic geopolitical risks, including global financial crises and “asset bubbles” that could put the international monetary, credit and financial system in danger. Thus, the present invention provides early warning on the formation of asset bubbles, financial crises and other risky or dangerous inflection points in the global financial system. The invention's trade name is “GovBrain Warning.”

The GovBrain system of web applications searches state, local, federal and international government websites and databases, including political and financial news sources, to provide real time insights for financial services clients. GovBrain links this information to individual stocks, bonds, commodities or currencies and processes it through an artificial intelligence/machine learning engine that predicts the price move for each stock or exchange traded fund.

The GovBrain system of web applications, used alongside this invention, allows end users to effectively monitor environments and conditions that could make a financial or credit crisis more likely. This invention conducts more effective surveillance of the global financial system and is an improvement on other non-software methods, procedures and human analysis processes used by organizations such as the International Monetary Fund (IMF) in Washington, D.C. The IMF is required by its charter to monitor and surveil the international monetary system and it could be argued that the IMF failed in its role to predict the 2007-8 global financial crisis using its current antiquated processes and procedures. Therefore, this invention is a novel improvement on other processes being used by similar organizations and market participants in the present day.

A main advantage of this invention is that it automates and improves current human analytical processes by leveraging GovBrain's proprietary computational power. For example, this invention, when used in conjunction with the GovBrain suite of products, better allows users to identify “boom-bust” sequences—when and where they start and when they end—before other traders, before other firms, and before various governmental agencies or nongovernmental organizations. GovBrain predictive analytics enables users to have better market and business intelligence and early warning on the possibility of a crisis or systemic failure in the financial system. The present invention builds on the GovBrain system of software that already utilizes artificial intelligence, machine learning, machine-generated prediction data and data science to automatically signal, predict and map environments, conditions or locations in which a global financial crisis or global market or credit bubble is more likely. This application also serves as a novel and unobvious way to monitor or conduct surveillance of the entire global financial system.

This invention also aggregates and analyzes predictions from a geographical area based on country, country capitols and continents or geographical areas and regions. The invention thus offers a unique and unobvious automated geopolitical risk and sentiment analysis based on open source intelligence to determine the investing climate, business climate and the latest business intelligence and analytics for individual countries. This novel and unobvious feature is a unique software process for an automated analysis for the geopolitical risk industry that other geopolitical risk firms cannot perform.

2. Description of Related Art

Entities that monitor or conduct surveillance of the global financial system who are not market participants are few in number and are not adequately equipped with automated predictive analytics performed by software. These entities include a small number of financial analysts and economists at obscure offices located in the U.S. Government and in international organizations.

The 2007-8 financial crisis is a cautionary tale about how various organizations failed to predict or warn policy makers and market participants of the dangers and problems in the global financial system. The GovBrain global financial crisis and bubble prediction application would improve and supplement existing human-based analysis systems of global economic and financial surveillance in the following organizations: U.S. Department of Treasury Office on International Affairs; U.S. Federal Reserve Office of Foreign Economies; International Monetary Fund (IMF); G20 and G7; World Bank; United Nations; and Organization for Economic Co-operation and Development (OECD).

This invention provides unique indicators that serve as an “early-warning system” in order to warn policy-makers, international organizations, market participants and corporate clients that an asset bubble or crisis is more likely over time (provided there are significant changes in the measurements or analysis of the predictive data). The term of art for this type of early warning analysis is known as “market intelligence (MARKINT).” MARKINT is a term of art currently used by the U.S. national security and intelligence community.

The invention is superior to other “doom, fear and greed” indices because it utilizes GovBrain's unique machine-generated prediction data on individual, stocks, bonds and currencies from all over the globe. The invention's automated process is “forward-looking”—an improvement over other doom and fear indices that use backward-looking economic and financial indicators collected by human analysts.

For example, the GovBrain system is more effective than the “CNNMoney Fear and Greed Index.” The CNNMoney Fear and Greed Index is mainly used for measuring and graphically representing equity sentiment in the United States. Alternatively, the GovBrain system is global and measures critical asset classes such as commodities and currencies. The CNNMoney index does not measure currencies or commodities. Portions of the CNNMoney index are sometimes not updated for weeks or months. The GovBrain stand-alone system makes constant individual predictions on securities nearly every minute and is not reliant on human inputs and analysis.

The CNNMoney index also uses the “Chicago Board Options Exchange Volatility Index (VIX).” Numerous critics allege that the VIX is a poor measurement of global volatility because it only focuses on options trading in one geographic location (Chicago, Ill.). GovBrain, through its real-time predictive analytics across additional asset classes beyond equities, is also superior to the VIX because GovBrain predicts assets across all continents around the world.

Another publicly-traded attempt to measure an overall level of volatility or “fear and greed” in financial markets is the “Nations VolDex Index.” The VolDex is a derivative instrument created by the International Securities Exchange that can be used for determining a general measure of implied volatility in financial markets. But the VolDex is focused on the trading of “at the money” options involving the U.S. Standard and Poor 500 exchange traded fund (SPY). GovBrain is also superior to the VolDex because the S&P 500 Index does not capture the price changes in international bonds, currencies or commodities. Thus it is a poor overall indicator of bubbles, crises or inflection points in the global financial system.

Corporations and financial market participants constantly seek analysis and forecasting based on geopolitical risk concerns. The industry that provides this type of analysis and forecasting is known as “political risk” or “geopolitical risk.” Geopolitical risk is a major factor that determines whether an investment fund or corporation will invest or do business in a country or geographic region, or whether institutional investors will trade certain financial securities, instruments and derivatives based in various countries or regions.

The entities that perform geopolitical risk are usually traditional bricks and mortar consulting firms that use human analysts who often manually-collect anecdotal data. These analysts often do not use modern state-of-the art software tools. These modern tools or processes would include machine learning, artificial intelligence or data science. The human-derived geopolitical analysis and research conducted by these firms focuses on the globalization of financial markets, political instability, international security threats and terrorism, transnational crime, foreign corruption, regime change, energy crises, governance, regulatory environments and global supply chain considerations.

Currently, geopolitical risk firms mostly offer only inadequate, antiquated and slow human-produced research and traditional analysis products such as written reports, white papers, conference calls and emails. Thus, the industry's state of the art is woefully unprepared to measure the level of geopolitical risk that is necessary for a fast-changing world. Human-generated geopolitical risk analysis is often not quantified and instead relies on qualitative research that can be biased and afflicted by groupthink, mirror imaging, ideological, historical, societal and cultural misinterpretation, bounded rationality and other cognitive constraints. These biases constrain and hinder the ability of human analysts to make correct recommendations to their clients concerning the appropriate level of risk management needed to derive the optimum amount of foreign direct investment or ideal security investment and derivative purchases and trading.

A few firms offer various indices based on human-derived models using multivariate regression analysis that ranks countries in numerical order based on their level of geopolitical risk. These models must be updated constantly by employees who live in foreign countries and employees who manually collect sparse anecdotal data in remote environments. This is a sluggish, costly and inefficient research methodology. Thus, the industry is ripe to be automated by software to improve efficiencies, re-allocate resources and reduce human labor costs in individual firms.

Verisk Maplecroft is a geopolitical risk firm that is headquartered in Bath, United Kingdom. Verisk Maplecroft, according to its corporate web site, offers “Verisk Maplecroft's Global Risks Forecast™”. This product, according to the firm's web site, offers a “world leading daily analysis and forecasting service that delivers critical insight into the issues that really count. Subscribers will benefit from the insights of Verisk Maplecroft's senior analysts, as they cut through complex issues to look at the drivers of global risk and opportunity, as well as at the trajectories of countries and future scenarios that can affect the investment climate.” The product appears to be based on software processes, but it also seems that it is dependent on updates and inputs from human analysts. Therefore, its software processes are not based on stand-alone automated sentiment analysis.

The Frontier Strategy Group is a geopolitical risk firm that is headquartered in Washington, D.C. This firm indeed has software tools, but the firm admits, according to its web site, that the software processes are based on human analysis and human input and not on stand-alone automated sentiment analysis. “That (data) is maintained monthly by FSG's global research team,” according to the firm's web site.

Cytora is a geopolitical risk firm located in London and Cambridge, England. According to the Cytora's corporate web site, its software extracts data in real-time from “blogs, social media, news media and RSS feeds.” This is a very similar software process that GovBrain currently uses in its automated search mechanism that is related to U.S. patent application Ser. No. 14/323,622, entitled “GovBrain® Method, Apparatus, and Computer Software,” filed on Jul. 3, 2014.

After extensive research was conducted by GovBrain Inc., we have determined that there are apparently no other software systems offered by geopolitical risk firms that are publicly-advertised and sold.

Alternatively, when compared to the other firms' software described above, this invention is based on stand-alone automated sentiment analysis that is conducted without human analysis and human input. The GovBrain system of web applications is integrated via an interactive dashboard track over 60 countries and regions. This invention automatically aggregates international security price predictions with statistical analysis to provide global investment sentiment and geopolitical risk analysis that can better drive investment decisions. Thus, this invention is a novel and unobvious software process that is a drastic improvement on existing human geopolitical risk analysis products.

### BRIEF SUMMARY OF THE INVENTION

The present invention is of a method (and concomitant non-transitory, computer readable medium comprising computer-readable code) for predicting a financial crisis event (and/or geopolitical risk), positive or negative, comprising: receiving from a user a date range and a geographical scope of interest; aggregating prediction data from the date range and geographical scope from one or more of the asset classes of currency, bond, commodity, and stock; automatically determining changes over time within the date range of one or more statistical analysis values of the aggregated prediction data selected from mean, median, mode, difference of means, standard deviation, variance, tolerance levels, skewness, kurtosis, inflection points and Bayesian analysis; and automatically reporting to the user a change outside of predetermined expected parameters. In the preferred embodiment, kurtosis is automatically determined, and most preferably automatically reporting occurs if kurtosis goes above the value of 3. Skewness is also preferably automatically determined, and most preferably automatically reporting occurs if the absolute value of skewness goes above 0.8.

Objects, advantages and novel features, and further scope of applicability of the present invention will be set forth in part in the detailed description to follow, and in part will become apparent to those skilled in the art upon examination of the following, or may be learned by practice of the invention.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a screenshot for the total aggregated sentiment across all asset classes including the “Government” category for Dec. 28, 2015. The user can also select other days, weeks, months, years, including year-to-date or the entire historical period.

FIG. 2 is a screenshot for the aggregated stock sentiment for “Microsoft (MSFT)” for the month of December, 2015.

FIG. 3 is a screenshot for the aggregated bond sentiment for “Treasury Bonds” for the month of December, 2015.

FIG. 4 is a screenshot for the aggregated currency sentiment for the “Japanese Yen” for the month of December, 2015.

FIG. 5 is a screenshot for the aggregated commodity sentiment for “Oil” for the month of December, 2015.

FIG. 6 is a screenshot for the aggregated government sentiment for “Obamacare” for an entire year from Dec. 28, 2014 to Dec. 28, 2015.

FIG. 7 is a screenshot that shows how the user can select a geographical region to get the geopolitical risk sentiment from a pulldown menu.

FIG. 8 is a screenshot that shows how the user can select a particular country to get the geopolitical risk sentiment from a pulldown menu.

FIG. 9 is another screenshot that shows how the user can select a particular country to get the geopolitical risk sentiment from a pulldown menu.

FIG. 10 is a screenshot that shows the aggregated geopolitical risk sentiment for the country “Russia,” for an entire year, from Dec. 28, 2014 to Dec. 28, 2015.

### DETAILED DESCRIPTION OF THE INVENTION

The invention uses GovBrain's proprietary machine-generated predictive data on the prices of individual stocks, bonds, currencies and commodities. Another category of predictive sentiment is the “Government” category. Thus GovBrain aggregates predictions from five different categories (four asset classes and Government). Additional detail on sentiment analysis software code is described in U.S. patent application Ser. No. 14/323,622, entitled “GovBrain® Method, Apparatus, and Computer Software.”

The application of the invention first uses a subset of the previous machine-generated prediction results from the Events table from the GovBrain system of applications. This size and make-up of the subset is based on user input. The application is able to focus on a day, a week, a month, quarter, year or a specified date-range for statistical analysis. MySQL is used to access the database and run those particular queries.

Then the application acquires and collects a subset of the machine-generated prediction data based on the date and time of the aggregated predictions using PHP and SQL. This requires user input to select the date and time range that is being examined or investigated—whether it is the previous one week of trading or the previous month of trading. The user can also select a series of date ranges that aggregates past weeks or months of predictions.

The user then selects the asset class that is being examined—whether it is a currency, bond, commodity, or stock or all four asset classes. The user can also select the entire globe or a specific country for visualization.

The application tests for normality for the subset or range of prediction data that was selected by the user and then runs various types of statistical analysis in PHP described earlier such as mean, variance, standard deviation, skewness and kurtosis.

The end user enters a date range in the form of YYYY-MM-DD HH:MM: SS (from)-(to) YYYY-MM-DD HH:MM: SS (NYC time zone) and then selects a region/country/geographic area from the dropdown, or to include All, selecting All (global).

The invention then runs a query against the database (MySQL) and returns the sentiment (additional detail on sentiment analysis software code is described in U.S. patent application Ser. No. 14/323,622, entitled “GovBrain® Method, Apparatus, and Computer Software”).

In addition to using (global) all—the invention also provides an interface for individual stocks, bonds, commodities, currencies, and government. Users may choose another input option or symbol. For example, to run an automated sentiment analysis on Microsoft, one would enter ticker symbol MSFT in Stocks. Over 5,000 publicly-traded corporations can be chosen by a user. Similarly, users may choose a currency—all the various currency symbols or titles around the world (euro (FXE), Japanese yen (FXY), Chinese yuan (CYB), etc.). They can choose a bond by entering the keyword for a bond under bonds (IE: municipal bond, treasury bond, corporate bond, sovereign bond, etc.). They can choose a commodity by entering the name or ticker symbol for a commodity (oil, natural gas, gold, silver, wheat, soybeans, etc.). For government, they can choose any government-related keyword from various subcategories of government actions such as regulations and laws such as the Affordable Care Act or Dodd-Frank. Users may choose the appropriate governmental institution around the world including city council, mayor, governor, state legislature, state attorney general, SEC, DOJ, FTC, FCC, EPA, FDA, Congress, British Parliament, Prime Minister, President or Chancellor.

GovBrain also aggregates and analyzes predictions from a geographical area based on country, country capitols and continents or geographical areas and regions. Over 60 countries and regions are tracked and available for analysis. This country data goes back nearly two years. The invention thus offers a unique and unobvious automated geopolitical risk and sentiment analysis to determine the investing climate, business climate and business intelligence and analytics for individual countries and regions. This novel and unobvious feature is a unique stand-alone process for an automated analysis for the geopolitical risk industry that other geopolitical risk firms cannot perform.

After appropriate normality tests are conducted, this predictive data results in a normal distribution that includes probability density functions and cumulative distribution functions. The invention constantly performs statistical analysis in PHP on the GovBrain machine-generated data aggregations. This statistical analysis in PHP includes but is not limited to mean, median, mode, difference of means, standard deviation, variance, tolerance levels, skewness, kurtosis, inflection points and Bayesian analysis.

Examples of this statistical analysis code in PHP include:

### Standard Deviation

stats_standard_deviation
float stats_variance (array $a[bool $sample=false])

### Variance

stats_variance
float stats_variance (array $a[bool $sample=false])

### Skewness

stats_skew
float stats_skew (array $a)

### Kurtosis

stats_kurtosis
float stats_kurtosis (array $a)

The invention can then automatically determine changes in the measurements over time. For example, if the GovBrain predictive data for a certain time period for any asset class skews negatively or positively, or if the variance and standard deviation change over any given time period, then this would be an indication that a global financial boom or bust sequence is more likely. Skewness and kurtosis measures the level of symmetry (or lack of symmetry) in the distribution and measures the flatness of the distribution. These measures give a user insight into the aggregations that are deviating from the mean in a manner that could foresee environments in which an asset bubble or financial crisis is more likely.

To categorize, represent, classify and describe sentiment, the invention uses the monikers “bullish”; “bearish”; or “neutral.” These terms are industry standard in finance and they are generally understood by lay persons. The invention assigns a numerical value for sentiment analysis that ranges from 1 to 10. If the sentiment value is from 4.5 to 5.5, the sentiment is neutral. If the value assigned is 5.5 to 10, the sentiment is bullish. If the value assigned is 1 to 4.5, the sentiment is bearish.

Thus these values form a normal distribution or a bell-shaped curve so that users can interpret the global sentiment by asset class (stocks, bonds, commodities or currencies) and by country or region.

The first statistical analysis is conducted by determining the mean of the normal distribution. If the mean of any given time period, asset class, country or region is between 5.1 and 5.2, the sentiment is slightly bullish. If the mean is between 5.3 and 5.4, sentiment is moderately bullish. If the mean is between 5.5 and 5.6, the sentiment is highly bullish. If the mean is greater than 5.7, the sentiment is extremely bullish.

Conversely, if the mean is between 4.9 and 4.8, the sentiment is slightly bearish. If the mean is between 4.7 and 4.6, the sentiment is moderately bearish. If the mean is 4.5 to 4.4, the sentiment is highly bearish. If the mean is less than 4.3, then the sentiment is extremely bearish.

Standard deviation can also be used to represent the level of concentration that the predictive data is around the mean. The following values denote the various subdivisions of the distributions. If the numerical value of the standard deviation is in the subdivision of 0 to 0.5, the sentiment is neutral. If the standard deviation is in the subdivision of 0.5 to 1, then the sentiment is slightly bullish. If the standard deviation is in the subdivision of 1.5 to 2, the sentiment is moderately bullish. If the standard deviation is then subdivision of 2.5 to 3, the sentiment is highly bullish. If the standard deviation is in the subdivision that is greater than 3, then sentiment is extremely bullish.

Conversely, if standard deviations are in negative values or in negative subdivisions from 0 to-3, then the sentiment is neutral, slightly bearish, moderately bearish, highly bearish and extremely bearish.

Variance is the “spread” or how far the predictive data is from the mean. It is often described as “variability.” Variance is proportionately similar to standard deviation since the standard deviation is the square root of variance. Variance can also be used to represent the level of risk or volatility. In finance, a high value of variance implies a higher level of risk or volatility.

Skewness can be used to determine either neutral, bearish or bullish sentiment in any given time period, asset class, country or region. If skewness is equal to 0, then the normal distribution is perfectly symmetric and is therefore a neutral sentiment. The following description appears counter-intuitive, but a negative value of skewness signifies a bullish sentiment and a positive value of skewness indicates a bearish sentiment. If skewness is greater than 0.5, then the sentiment is slightly bearish. If skewness is greater than 0.6, then the sentiment is moderately bearish. If the skewness is greater than 0.7, then the sentiment is highly bearish. If the skewness is greater than 0.8, then the sentiment is extremely bearish. Conversely, negative values of skewness indicate similar levels of bullish sentiment.

The numerical value of kurtosis is a volatility measure to determine risk levels in in any given time period, asset class, country or region. In the financial industry, kurtosis is referred to as the “volatility of volatility.” This means a user can see risky or less risky trends over time, all else equal. Kurtosis also describes the “shape” or “spikiness” of a graphical representation of a normal distribution. A flatter distribution has a negative kurtosis. A spiky distribution has a positive kurtosis. When the kurtosis of a normal distribution is not skewed (or if there is no skewness), the financial industry may assign it a numerical coefficient value of 3 for a normal distribution. Therefore, high or excess levels of kurtosis coefficients larger than 3 can be indicators of higher volatility and higher risk. Alternatively, low kurtosis levels below 3 can indicate lower volatility or less risk over time, all else equal. So kurtosis may also be an indicator of the likelihood of extreme times of gains or losses and an indicator of the likelihood of boom and bust periods.

The invention then plots and graphically visualizes the predictive data from each asset class, country and time period.

Visualization of the aggregated machine-generated predictions is then possible by using global mapping application programming interfaces to plot the geographic location of where financial contagion is spreading during times of booms, busts or bubbles.

When using a map to visualize the geographic location of the asset class, such as the capital of the country's currency or the geographic location of the stock's corporate headquarters, or when a user chooses a country or region via the dropdown menu, the locations are plotted using Google Maps API Version 3 and/or Google Earth API using JavaScript.

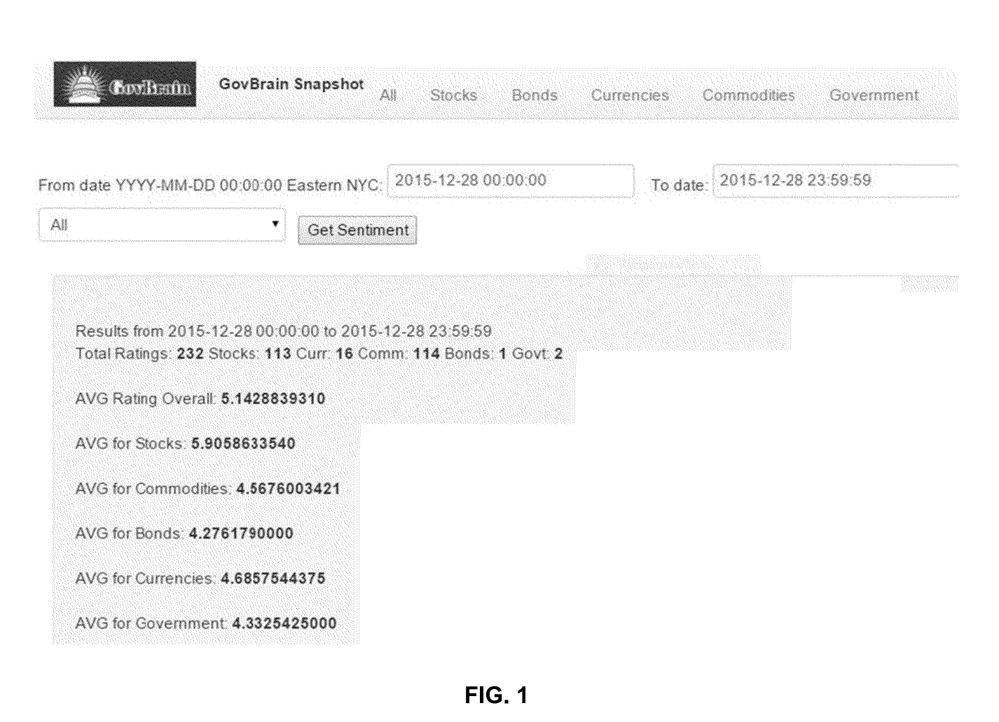

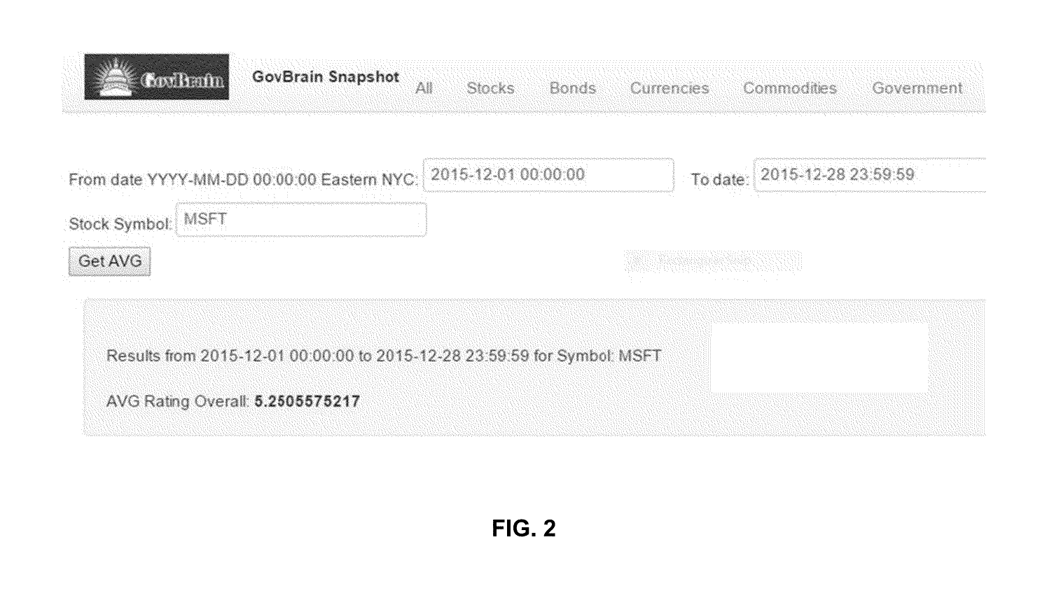

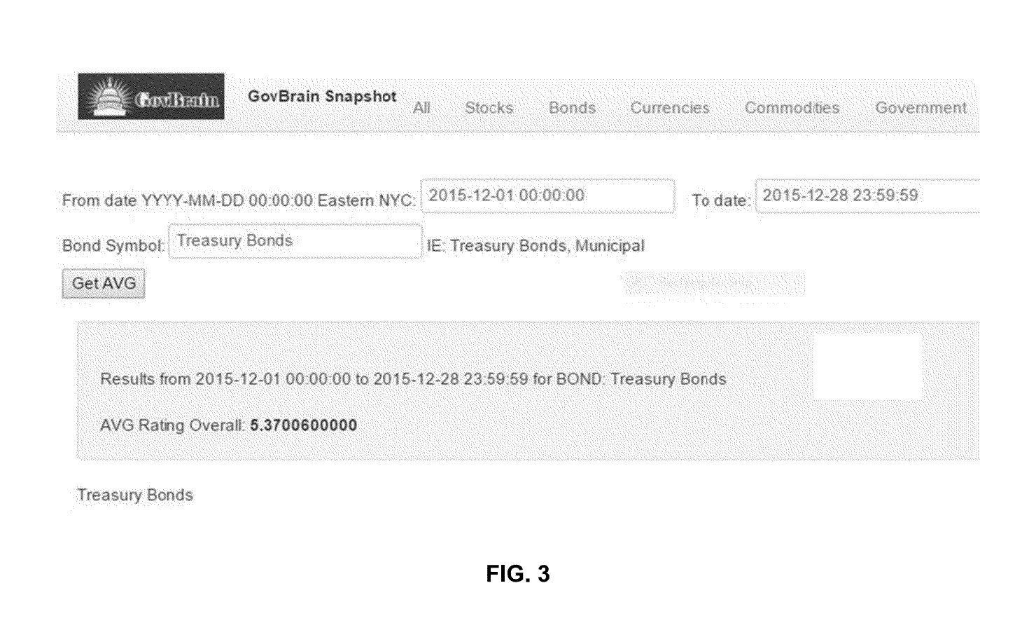

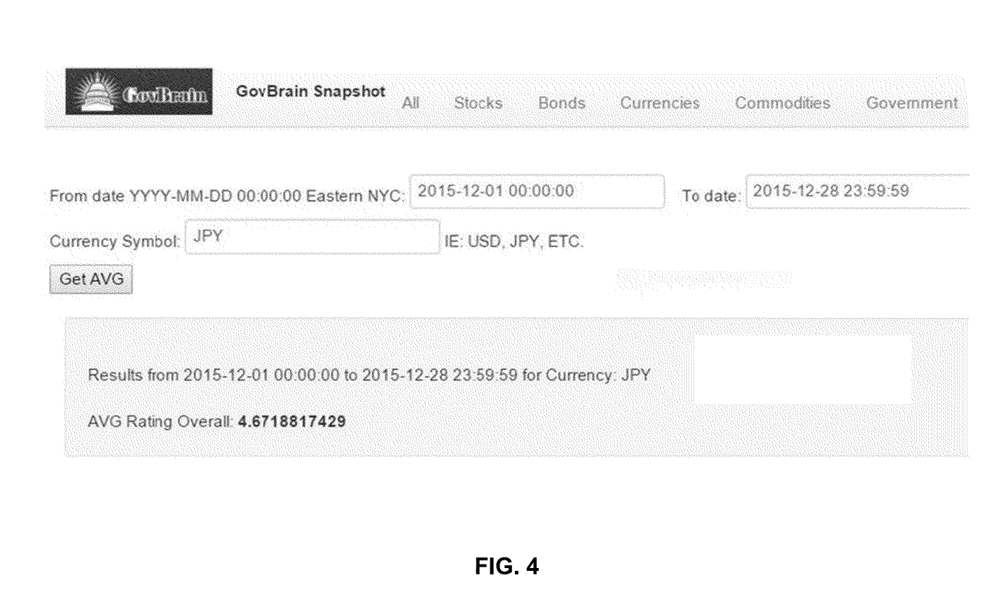

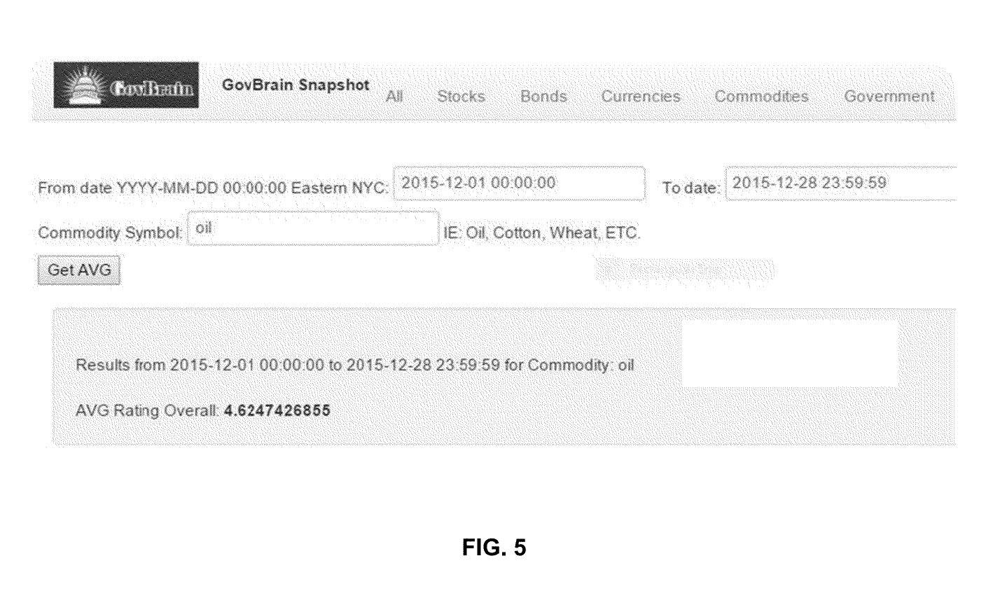

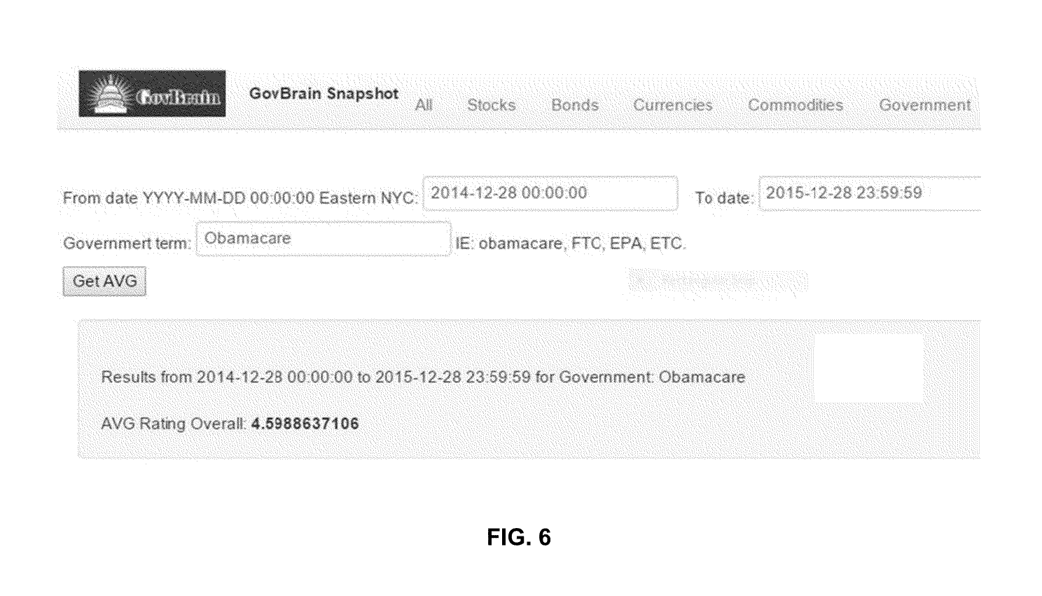

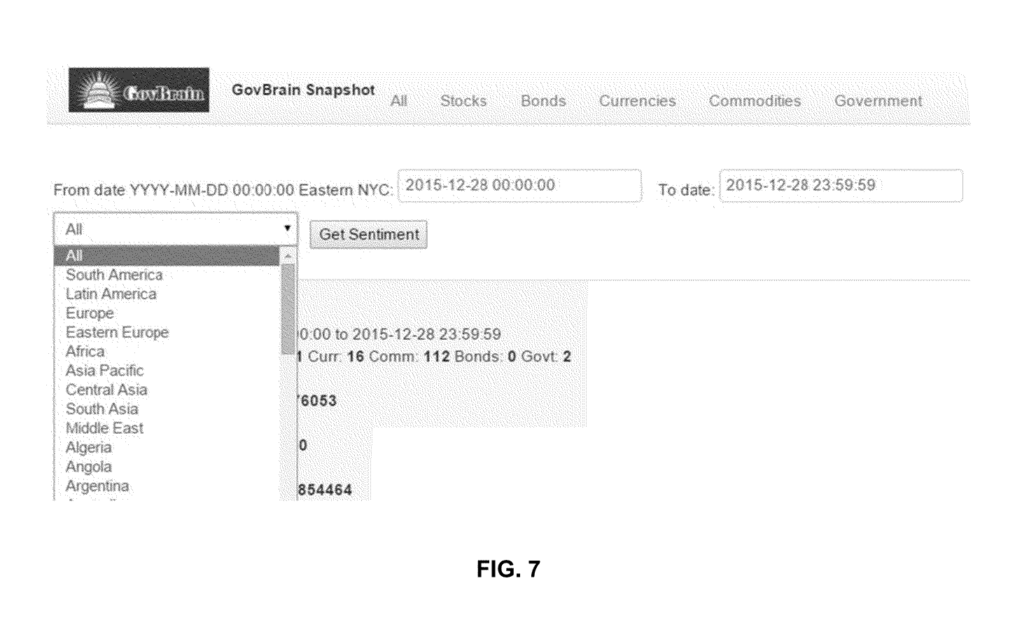

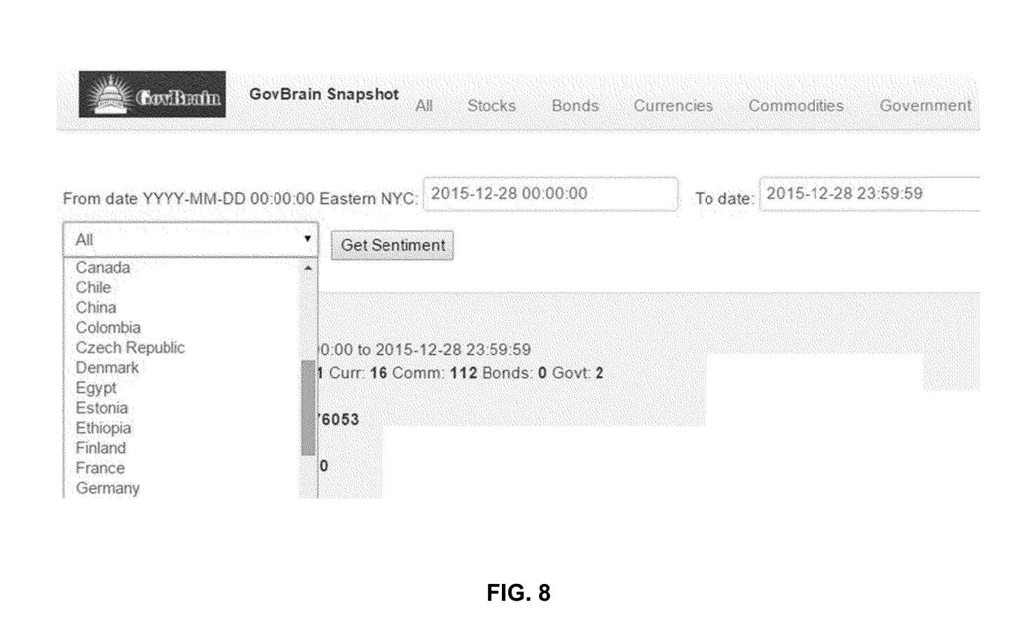

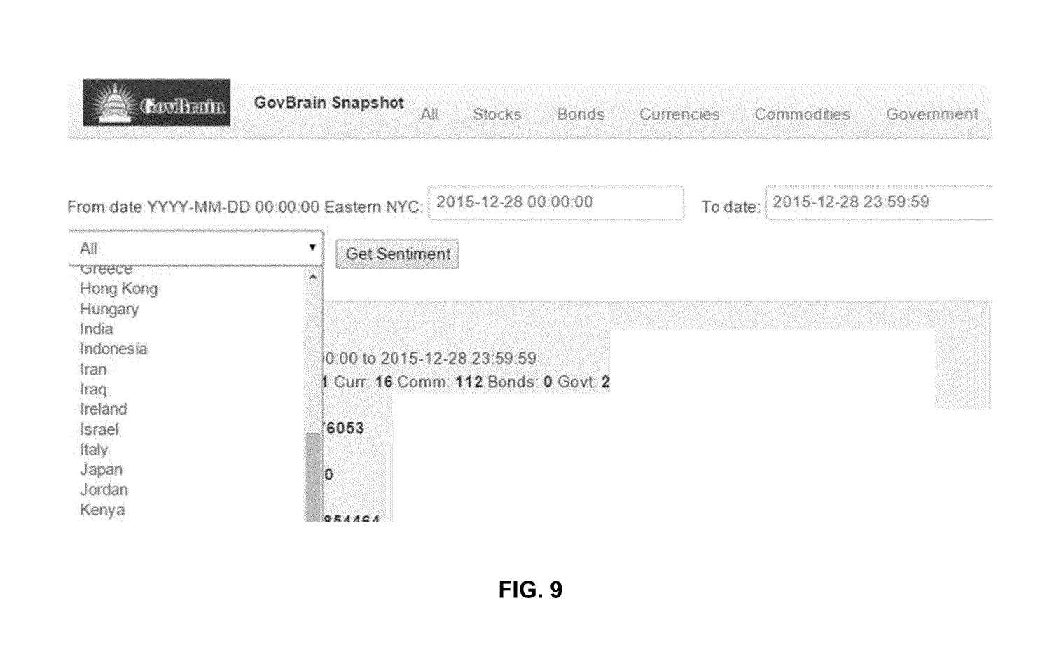

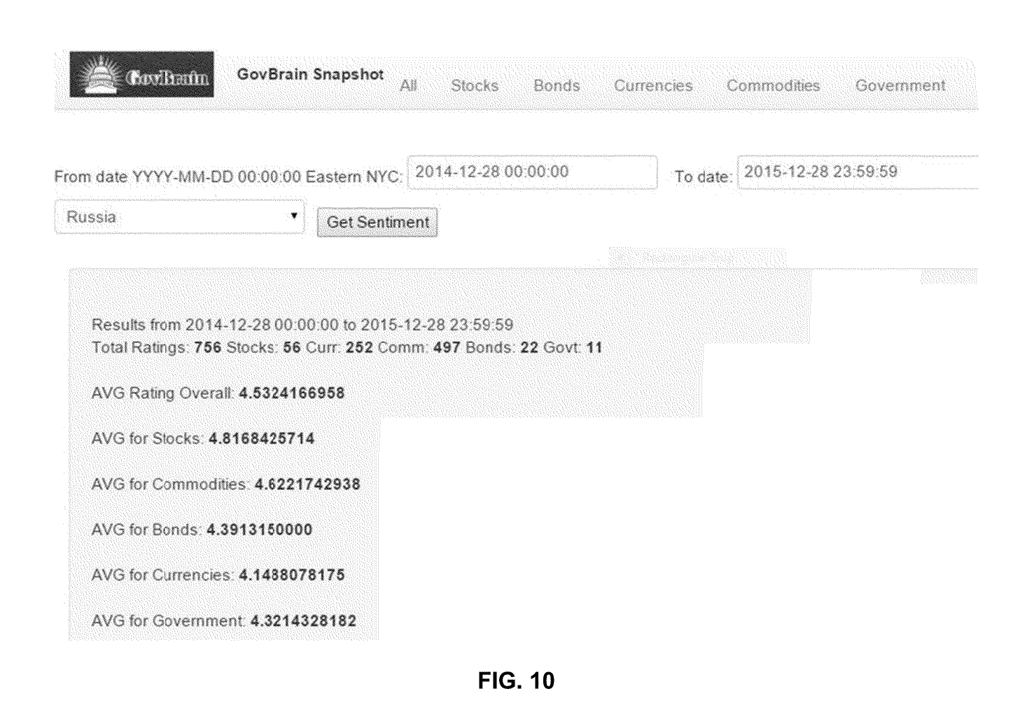

FIGS. 1-10 provide a series of screenshots for a dashboard or user interface for using the invention via the world-wide web. The end user selects “Snapshot” from the GovBrain dashboard of web applications. The end user enters a date range in the form of YYYY-MM-DD HH:MM: SS (from)-(to) YYYY-MM-DD HH:MM: SS (NYC time zone) and then selects a region/country/geographic area from the dropdown. The user can select “All” to receive sentiment from all countries and regions (FIG. 1). FIGS. 7-10 show how the user can select the geographical region or country from a pulldown menu. The invention then runs a query against the database (MySQL) and returns the sentiment results. In addition to using (global) all—the invention also provides an interface for individual stocks, bonds, commodities, currencies, and government. In these screenshots we add another input option or symbol. For example, to run a sentiment analysis on the stock symbol from Microsoft, the user would enter symbol MSFT in Stocks (FIG. 2). The user can enter stock ticker symbols for approximately 5,000 publicly-traded companies around the world. Similarly, for a bond, the description for a type of bond can be entered such as “Treasury Bonds,” (FIG. 3). For a currency, the currency symbol under currencies can be entered such as “JPY” for the Japanese Yen (FIG. 4). All major currencies from around the world can be entered. For a commodity, the description for a commodity can be entered such as “Oil,” (FIG. 5). All hard and soft commodities publicly-traded from around the world can be entered to get an automated sentiment. For government, any government keyword such as FTC, FCC, or Obamacare, can be selected for government sentiment (FIG. 6). The screenshots also offer the user the ability to choose in a dropdown menu the aggregated geopolitical risk and sentiment analysis of at least 60 different countries and geographical regions (FIGS. 7-9). FIG. 10 shows how a user can select a particular country (Russia) and a particular time (Dec. 28, 2014 to Dec. 28, 2015) to get an automated geopolitical risk analysis for Russia.

In the preferred embodiment, and as readily understood by one of ordinary skill in the art, the apparatus according to the invention will include a general or specific purpose computer or distributed system programmed with computer software implementing the steps described above, which computer software may be in any appropriate computer language, including C++, FORTRAN, BASIC, Java, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements.

Note that in the specification and claims, “about” or “approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A method for predicting a financial crisis event, positive or negative, the method comprising the steps of:
receiving from a user a date range and a geographical scope of interest;
aggregating prediction data from the date range and geographical scope from one or more of the asset classes selected from the group consisting of currency, bond, commodity, and stock;
automatically determining changes over time within the date range of one or more statistical analysis values of the aggregated prediction data selected from the group consisting of mean, median, mode, difference of means, standard deviation, variance, tolerance levels, skewness, kurtosis, inflection points and Bayesian analysis; and
automatically reporting to the user a change outside of predetermined expected parameters.

2. The method of claim 1 wherein kurtosis is automatically determined.

3. The method of claim 2 wherein automatically reporting occurs if kurtosis goes above the value of 3.

4. The method of claim 1 wherein skewness is automatically determined.

5. The method of claim 4 wherein automatically reporting occurs if the absolute value of skewness goes above 0.8.

6. A method for predicting geopolitical risk, positive or negative, the method comprising the steps of:
receiving from a user a date range and a geographical scope of interest;
aggregating prediction data from the date range and geographical scope from one or more of the classes selected from the group consisting of currency, bond, commodity, stock, and government;
automatically determining changes over time within the date range of one or more statistical analysis values of the aggregated prediction data selected from the group consisting of mean, median, mode, difference of means, standard deviation, variance, tolerance levels, skewness, kurtosis, inflection points and Bayesian analysis; and
automatically reporting to the user a change outside of predetermined expected parameters.

7. The method of claim 6 wherein kurtosis is automatically determined.

8. The method of claim 7 wherein automatically reporting occurs if kurtosis goes above the level of 3.

9. The method of claim 6 wherein skewness is automatically determined.

10. The method of claim 9 wherein automatically reporting occurs if the absolute value of skewness goes above 0.8.

11. A non-transitory, computer-readable medium comprising computer-readable code for predicting a financial crisis event, positive or negative, the code comprising:
code receiving from a user a date range and a geographical scope of interest;
code aggregating prediction data from the date range and geographical scope from one or more of the asset classes selected from the group consisting of currency, bond, commodity, and stock;
code automatically determining changes over time within the date range of one or more statistical analysis values of the aggregated prediction data selected from the group consisting of mean, median, mode, difference of means, standard deviation, variance, tolerance levels, skewness, kurtosis, inflection points and Bayesian analysis; and
code automatically reporting to the user a change outside of predetermined expected parameters.

12. The medium of claim 11 wherein kurtosis is automatically determined.

13. The medium of claim 12 wherein automatically reporting occurs if kurtosis goes above the value of 3.

14. The medium of claim 11 wherein skewness is automatically determined.

15. The medium of claim 14 wherein automatically reporting occurs if the absolute value of skewness goes above 0.8.

16. A non-transitory, computer-readable medium comprising computer-readable code for predicting geopolitical risk, positive or negative, the code comprising:
code receiving from a user a date range and a geographical scope of interest;
code aggregating prediction data from the date range and geographical scope from one or more of the classes selected from the group consisting of currency, bond, commodity, stock, and government;
code automatically determining changes over time within the date range of one or more statistical analysis values of the aggregated prediction data selected from the group consisting of mean, median, mode, difference of means, standard deviation, variance, tolerance levels, skewness, kurtosis, inflection points and Bayesian analysis; and
code automatically reporting to the user a change outside of predetermined expected parameters.

17. The medium of claim 16 wherein kurtosis is automatically determined.

18. The medium of claim 17 wherein automatically reporting occurs if kurtosis goes above the level of 3.

19. The medium of claim 16 wherein skewness is automatically determined.

20. The medium of claim 19 wherein automatically reporting occurs if the absolute value of skewness goes above 0.8.
